(19) United States
(12) Patent Application Publication
(10) Pub. No.: US 2016/0203543 A1
(43) Pub. Date: Jul. 14, 2016

(54) SYSTEM AND METHOD OF PROVIDING ACCURATE, TIMELY AND PRECISE PICKUP TIME FOR ONLINE ORDERING

(71) Applicant: Eric Adam Snow, Toronto (CA)

(72) Inventor: Eric Adam Snow, Toronto (CA)

(21) Appl. No.: 14/991,549

(22) Filed: Jan. 8, 2016

Related U.S. Application Data
(60) Provisional application No. 62/101,419, filed on Jan. 9, 2015.

(51) Int. Cl. G06Q 30/06; G06Q 10/06

(52) U.S. Cl. CPC G06Q 30/0635; G06Q 10/063114; G06Q 10/06316

(57) ABSTRACT

A method is provided for providing an accurate, timely and precise pickup time for a multi-product order. A first item selection in an order is received from a user through an online order interface. A second item to be added to the order is received from the user through the interface. A first pickup time is calculated based on a factorial assessment, including locational dispersion of the items. This is provided to the user. The user can change or delete any of the items to modify the first pickup time before finalizing the order. Picking of the order is dynamically tracked at the picking facility and a second pickup time is calculated based on the completion of the picking of the order. This is provided to the user, as a modification of the first pickup time. A picker device is also provided.

### CROSS-REFERENCE TO RELATED APPLICATION

This application claims the benefit of U.S. Provisional Patent Application No. 62/101,419, filed Jan. 9, 2015, which is incorporated herein by reference in its entirety.

### FIELD OF THE INVENTION

The invention relates to online ordering systems and more particularly relates to predictive systems for picking times for order completion.

### BACKGROUND

Merchants want to service a higher volume of consumers without jeopardizing the normal flow of traffic into their stores. Companies are also trying to reduce retail location footprints, as rents and other real estate costs continue to impact margins. Online ordering offers a way of reducing the retail footprint while also providing a convenience to the consumers.

Consumers want more control of their time. Thus online ordering is becoming the norm as consumers are busier than ever and do not want to waste time doing mundane activities. At its core, convenience is the fundamental reason people shop online. Poor performance at any point during the shopping experience can sway consumers to question the value proposition of the service offering.

Several options are available to consumers when placing online orders for groceries. Whether it is by pickup or delivery, the service provider creates appointments whether it is for a 2-hour window the following day or even delivery/pickup within an hour, the scheduling of the offering is catered towards the merchant and not the customer requiring the service.

Prior art methods and system for online ordering and delivery lack the ability to provide an accurate, timely and precise pickup time to a user when placing an order online. In existing methods, a user placing an online order and wanting to pickup the order is either given an artificially-padded estimate time of pickup, or has to make an appointment for a given time to pickup the order or, in worst case, is left guessing. This delay and uncertainty leads to a less than perfect experience.

It's 5 pm, and John Doe is leaving work. He would like to know if he can get his groceries delivered or picked up before he has to take Johnny for soccer practice at 6 pm. Unfortunately, on-demand grocery delivery platforms that provide an option for delivery within one-hour do not solve John's problem because they cannot provide an accurate, timely or precise time for order completion. It may take 20 minutes or 55 minutes! John does not have any control over the final delivery time. He would just like the groceries available as soon as possible.

Appointment windows fail to provide true convenience to consumers. There is an outstanding need for a system and method that provides enhanced customer service by optimizing ordering efficiency and enhanced accuracy and predictability for consumer pickup time on an “as soon as possible” basis rather than a “just in time” basis. It is expected that this would in turn lead to increased revenues for merchants.

### SUMMARY OF INVENTION

Broadly speaking, the present invention relates to a system and method of electronic online ordering and in particular relates to providing an accurate, timely and precise pickup time to the user at the time the online order is placed. In this disclosure, even when not stated expressly, the term “accurate” shall also be understood to connote “timely” and “precise”.

In one embodiment, the system and method provides an accurate pickup time for the ordered products. In one embodiment, the accurate pickup time can be calculated after the user has placed the order and checked out.

The accurate pickup time can be real time i.e. as the user adds items to the electronic shopping cart the pickup time estimate is adjusted accordingly. If a user is in a real hurry, the user can adjust the pickup time (shorten the wait) by not ordering a certain non-essential item since the order will be assembled faster by excluding the said item. The user has the option to delete or modify the non-essential item.

In the preferred embodiment, the system and method may be implemented on a server that is internet accessible. An online order may be placed from a connected computer e.g. a desktop that is connected to the internet or from a mobile device like a Smartphone, a tablet or the like. The invention can be advantageously practiced on devices including, but not limited to, an iPhone, iPad, Smartphones, Android phones, personal computers e.g. laptops, tablet computers, touch-screen computers running any number of different operating systems e.g. MS Windows, Apple iOS, Linux, Ubuntu, etc.

A user interface is provided which presents an accurate pickup time to the user. For example, when a user places an online order using a browser running on a computing device like a tablet, the accurate pickup time may be displayed on a particular area of the browser and/or screen to indicate to the user that the order will be ready for pickup at a specified time.

In an alternate embodiment, the invention may be an app (application) specifically designed for online orders and geared to the merchandise of the vendor. The app may be designed to run on a specific operating system e.g. an app designed to run on an iPad, an app designed to run on an Android Smartphone or an app that is designed using Flash or HTML5 that can run or any device supporting that protocol. The details may vary from one implementation to another and the above are exemplary.

The user may also be presented with the accurate pickup time via an e-mail, a text message, a voice mail, a link being added to the homepage on a social media website e.g. Facebook homepage. In an alternate embodiment there may be an application, either generic or purpose built, such that the user can place an online order using this application. The application may be specific for a particular mobile device e.g. an iPhone or a Google Android phone, or a tablet computer etc. or generic e.g. Flash or HTML5 based app that can be used in a browser.

In one embodiment, the system may also provide a notification service. The notification service may provide a notification to the user indicating the remaining time until the order is ready. The notification service may also provide periodic reminders. Such notifications may also be sent via e-mail, text message, phone call, via a purpose built application etc. or via a social network e.g. Facebook page, Google+, Twitter etc.

In one embodiment, the invention gathers order metrics over a period of time. The system may gather information about orders and the specific items in each order over a period of time and then continue to refine this gathered data as more orders are placed, in order to derive more sophisticated averages in picking time, evaluate various individual pickers, etc.

In one embodiment, the invention calculates average order size. The system may gather information about orders and the specific items in each order and calculate the average size of an order. The average order size may include the number of items, the quantity of each item etc. For example, if the system and method are implemented at a grocery store, where the user places the order online for different grocery items, the analysis of orders placed by many different grocery shoppers over a period of time may be used to calculate the average order size.

In one embodiment, the invention calculates the average time it takes to assemble the average order. Also, the invention may calculate the average time it takes to assemble an average order based on the information gathered over a period of time by taking many different orders placed by multiple users for different products.

In one embodiment, when calculating the accurate pickup time for an order, several factors may be taken into account, such as: the number of items in the order, where the items in the order are shelved, the product dispersion of the items in the store e.g. how far apart in the store are the items in the order, how the instant order compares with an average order, how many pickers are on shift, how many pickers are available at the present time (as some may be on shift but on break), average picker speed in assembling an order, personal variations between individual pickers on shift, how many other orders are in queue, etc. These factors and others may be used to calculate the accurate pickup time for the ordered products. It is a learning algorithm that improves and evolves as the extent of picking data grows over time.

In one embodiment, when calculating an accurate pickup time for the ordered products the system considers whether the picking location is retail or warehouse, and the size of the location. For instance, the picking facility may be a small retail store, a standard grocery store, a super store, or a distribution centre or a warehouse. The system may consider the square footage of the location as well as whether there are multiple levels in the location. The placement of products in the location may also be considered, i.e. where items are shelved/placed and how far are they from each other. Whether the location is manual or mechanized may also be considered; e.g. trolleys are manual or mechanized. If the location is manual, then manual averages may be applied, whereas if the location is mechanized mechanized averages may be applied. Likewise, where automated or robotic picking technology is available, appropriate averages may be applied. Special packaging or handling requirements may also be considered, e.g. if order is to be boxed or bagged, or placed in a temperature controlled container.

In one embodiment, the server receives an order and checks the picker schedule. In one embodiment, the server sends the order to the next available picker while in an alternate embodiment, the server may send the order to a picker best suited for the picking/assembling of the order, or may send the order to more than one picker to assemble. The order may be split among multiple pickers and the picked items combined and assembled at the end for pickup.

The order may be assigned to a picker in any number of different ways e.g. e-mailed to a mobile device like a Smartphone carried by the picker, a connected tablet mounted on a trolley or other cart or the picker may be provided with a paper based print out of the ordered items etc. Once a picker has received an order to assemble the picker schedule status is updated with the server and the picker is now considered “busy” after having received a new order.

In one embodiment, the picker adds products from the order in the trolley, and the picker checks off the picked item. Once the order is complete, the order complete status is sent to the server and the picker becomes available in the schedule and ready to receive next order.

In an alternate embodiment, as the picker assembles the order, the status is updated with the server as each item from the order is added to the trolley, and this status can be shown to the user via the graphical user interface in real time.

The preferred embodiment uses the grocery store as the example, but in fact the invention or its embodiments may also be advantageously implemented at other stores like a Big Box home improvement store or a pharmacy.

In one embodiment, payment for the order may be made online when the order is placed by a user. In another embodiment, payment can be made by the user placing the order at the time of pickup. While in yet another embodiment, payment can be made using a loyalty card or by using points or other rewards accumulated by the user over a period of time.

According to a first aspect of the invention, a method is provided for providing an accurate, timely and precise pickup time for a multi-product order. A first item selection in an order is received from a user through an online order interface. A second item to be added to the order is received from the user through the interface. A first pickup time is calculated based on a factorial assessment. The assessment includes as one factor the locational dispersion of the items from each other in a picking facility. A first notification is provided to the user of the first pickup time. The user is allowed to change or delete any of the items to modify the first pickup time before finalizing the order. Picking of the order is dynamically tracked at the picking facility and a second pickup time is calculated based on the completion of the picking of the order. A second notification is provided to the user of the second pickup time, as a modification of the first pickup time in order to provide an “as soon as possible” pickup time.

The factorial assessment may further include any of the following:
the number of items in the order;
the position of each of the items on shelves in the picking facility;
a schedule of pickers in the picking facility;
current or near-term availability of pickers in the picking facility (including temporary absences due to breaks, washroom, unplanned emergencies, etc.);
speed of pickers in the picking facility;
orders in queue for the picking facility prior to the user's order;
specific packaging requirements for any of the items in the order;
overall size (and configuration or arrangement) of the picking facility; and/or
availability of manual or mechanized trolleys in the picking facility.

The user may be further allowed to enter a desired pickup time. In this case, the first notification advises the user if the desired pickup time is unobtainable given the calculated first pickup time. If unobtainable, the user may be allowed to revise either the order or the desired pickup time.

Preferably, the first pickup time is displayed as a running total as the items are added to the order. The item picking completion may also be displayed to the user in real-time.

For example, the locational dispersion may comprise the minimum straight-line distance between the items, or the minimum (shortest) picker path distance between the items. Locationally-adjacent items may be grouped or ordered together prior to calculation of locational dispersion.

Tracking the picking of the order may be by picker- or trolley-mounted tracking device.

In one embodiment, the picking facility is a grocery store, or a distribution centre or a warehouse of a grocery store.

According to a second aspect of the invention, a picker device is provided for providing an accurate, timely and precise pickup time for a multi-product order to be picked by a picker in a picking facility. The device includes generally a picker- or trolley-mounted portion, and a device portion. The device portion includes programming to receive an order for picking. The order includes multiple items, and a first pickup time that had been previously provided to a user when the order was entered. The order is displayed to the picker such that the items are arranged according to minimum product dispersion in the picking facility. An indication from the picker or the trolley is received that the item has been picked. A second pickup time is calculated based on actual completion of the order for pickup. The first pickup time is preferably displayed to the picker.

Preferably, the device portion is also programmed for tracking and displaying to the picker the progress to completion of the order. Points or credits may be assessed to the picker if the first pickup time is met or improved.

The order is marked complete when all items have been picked and packaged for pickup.

The device portion may be further programmed for giving visual or audio directions as to the location of the next item for picking.

### BRIEF DESCRIPTION OF THE FIGURES

FIG. 1 is a flow diagram of a basic process for the online ordering system.

FIG. 2 is a flow diagram of order metric gathering.

FIG. 3 is a flow diagram of a sample factorial assessment for arriving at an accurate, timely and precise pickup time.

FIG. 4 is a flow diagram illustrating locational factors in the factorial assessment.

FIG. 5 is a flow diagram illustrating picker device process.

### DETAILED DESCRIPTION

Before embodiments are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium. In order to provide a context for the various aspects of the disclosed invention, as well as the following discussion are intended to provide a brief, general description of a suitable environment in which the various aspects of the disclosed invention may be implemented. While the invention has been described in the general context of computer-executable instructions of a program that runs on one or more computers, the invention also may be implemented in combination with other program modules. Generally, program modules include routines, programs, components, data structures, etc. that perform particular tasks and/or implement particular abstract data types. Moreover, the system and method may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch or other electronic gadgets incorporating the capacity to compute), microprocessor-based or programmable consumer or industrial electronics, and the like. The illustrated aspects may also be practiced in distributed computing environments where tasks/routines/processes etc. are performed by remote processing devices that are linked through a communications network e.g. a local area network (LAN) or the Internet. However, some, if not all, aspects may be practiced on stand-alone computer(s). In a distributed computing environment, program modules may be located in both local and remote memory storage devices.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages. Additionally, computer code may also be written using a web programming stack of software, which may mainly be comprised of open source software, usually containing an operating system, Web server, database server, and programming language. Some embodiments may use well-known open-source Web development platforms using Linux, Apache, MySQL and PHP. Other examples of environments and frameworks using which computer code may also be generated are Ruby on Rails which is based on the Ruby programming language, or node.js which is an event-driven server-side JavaScript environment. In the present case, the code is specialized to execute functions described herein which enables a smoother and more efficient technological process.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Computing devices that enable a user to engage with the internet in general and place an online order may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a USB memory key, flash memory, or other type of memory media all collectively referred to as “removable media” in this disclosure. The app may also be downloaded from the internet. The removable media can be inserted to the console of a computing device where it is read. The console can then read program instructions stored on the removable media and present a user interface to the user. The user interface may preferably be a graphical user interface (GUI). Example of such computing devices are personal computers e.g. a laptop or a Mac, a Smartphone, a tablet, a SmartTV, etc.

However, there are many different ways of implementing the present invention in computer programming and using various devices. The invention should not be construed as limited to any one set of computer program instructions, or any one architectural configuration. Further, a skilled programmer would be able to write such a computer program and configure such a system based on the appended flow charts and associated description. Therefore, disclosure of a particular set of instructions or a particular system configuration is not considered necessary for an adequate understanding of how to make and use the present invention.

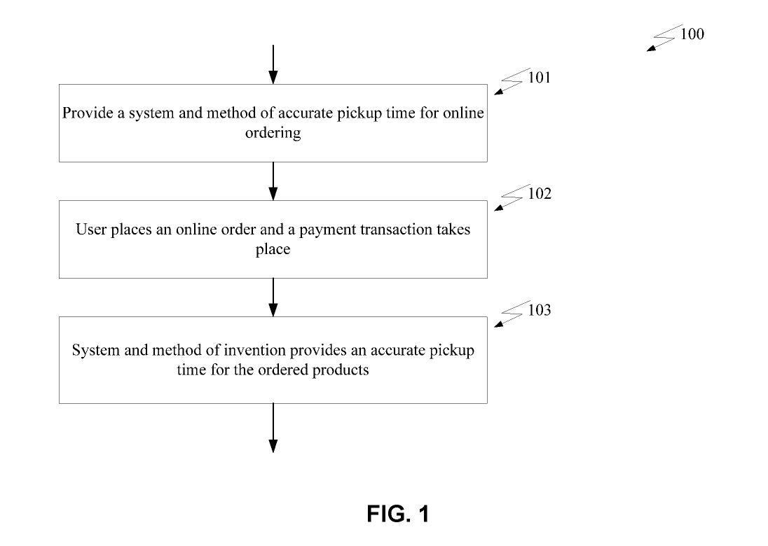

FIG. 1 shows the preferred embodiment of the basic process for the present online ordering system 100. A system and method is provided of accurate pickup time for online ordering 101. In the preferred embodiment, the system and method may be implemented on a server that is accessible over the Internet.

In alternate embodiments, the system and method may be implemented on a cluster of servers which are accessible over the internet or other network.

The user places an online order and a payment transaction takes place 102. A user may place an online order by accessing the server over the internet using a connected device. For example, the user may use a computing device like a tablet with a browser installed on it, or may use a personal computer where a browser is installed or a mobile device like a Smartphone which has a purpose built app installed on it. The invention can be advantageously practiced on a variety of devices including but not limited to an iPhone, iPad, Smartphones, Android phones, personal computers e.g. laptops, tablet computers, touch-screen computers running any number of different operating systems e.g. MS Windows, Apple iOS, Linux, Ubuntu, etc. The user may place the order through a standalone app or as part of a digital wallet.

In some embodiments, the computing device is portable. In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. In some embodiments, the functions may include providing maps and directions, telephoning, video conferencing, e-mailing, instant messaging, blogging, digital photographing, digital videoing, web browsing, digital music playing, and/or digital video playing. Instructions for performing these functions may be included in a computer readable storage medium or other computer program product configured for execution by one or more processors.

The system and method provides an accurate pickup time for the ordered products 103. In this disclosure, even when not stated expressly, the term “accurate” shall also be understood to connote “timely” and “precise”.

A user interface is provided whereby an accurate pickup time is presented to the user. For example, the user may place an online order using a browser running on a computing device like a tablet. Thus the accurate pickup time may be displayed on a particular area of the browser to indicate to the user that the order will ready for pickup in the specified time. As an example the display may show: “Order will be ready for pickup in 45 minutes at 3:50 pm”. This allows the user to pickup the order as soon as possible. The merchant may also be notified when the user arrives for grocery pickup.

In an alternate embodiment, there may be an app (application) specifically designed for online orders and geared to the merchandise of a particular vendor. The app may be designed to run on a specific operating system e.g. an app designed to run on an iPad, an app designed to run on an Android Smartphone or an app that is designed using HTML5 and can run or any device supporting that protocol. The details may vary from one implementation to another and the above are exemplary.

In one embodiment, the accurate pickup time can be calculated in real time i.e. as the user adds/deletes items to/from the electronic shopping cart in an online order, the pickup time is adjusted accordingly.

In an alternate embodiment, the accurate pickup time may be calculated after the user has placed the order and checked out.

The user may also be presented with the accurate pickup time via an e-mail, a text message, a voice mail, a link being added to the homepage on a social media website e.g. Facebook homepage. In an alternate embodiment an application may be provided (either generic or purpose built) which allows the user to place an online order. The application may be specific for a particular mobile device e.g. an iPhone or a Google Android phone, or a tablet computer etc. or generic e.g. Flash or HTML5 based app that can be used in a browser.

In one embodiment, the system may also provide a notification service. The notification service may provide a notification to the user counting down (or showing the remaining) time until the order is ready. The notification service of the system may also provide periodic reminders. Such notifications may also be sent via e-mail, text message, phone call, via a purpose built application etc. or may be via a social network e.g. Facebook page, Google+, Twitter etc.

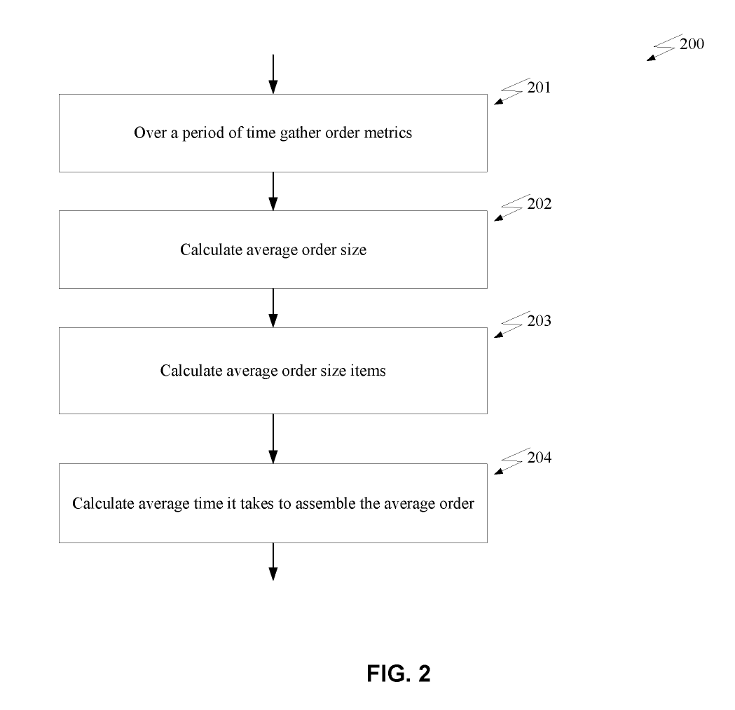

FIG. 2 shows one embodiment of the flow of order metric gathering 200. Over a period of time, order metrics are gathered 201. The system may gather information about orders and the specific items in each order over a period of time and then continue to refine this data as more orders are placed.

An average order size may be calculated 202. The system may gather information about orders and the specific items in each order and calculate the average size of an order (e.g. typical number of bags or boxes, number of items, typical dollar value of the order, etc.). The average order size may include the number of items, the quantity of each item etc. For example, if the system and method are implemented at a grocery store, where the user places the order online for different items, the analysis of orders placed by many different users over a period of time may be used to calculate the average order size.

The number of items in the average order size is calculated 203. The average order size is calculated based on multiple orders received from a wide range of users over a period of time. The size of a given order compared to an average order can provide a benchmark for the length of time it will take to pick/assemble the said order.

The average time it takes to assemble the average order is calculated 204. The average time it takes to assemble an average order based on the information gathered over a period of time is calculated by taking many different orders placed by multiple users for different products.

In one embodiment, the system may be initialized with “seed data” that may have been acquired as a result of sample orders (mock orders) that are run to gather average time to assemble the order. In an alternate embodiment, the seed data may also include some real orders initially received by the system. The seed data can then be combined with real data as it is gathered from receiving and fulfilling a wide range of online orders over a period of time.

One embodiment may employ “runners” who are assigned to take an assembled order to the consumer's vehicle which may be parked in a designated order pickup spot in the parking lot. The average time for a runner to take an order from the check out or other location within the retail environment to the parked consumer vehicle may also be calculated and used when providing an accurate pickup time to a consumer.

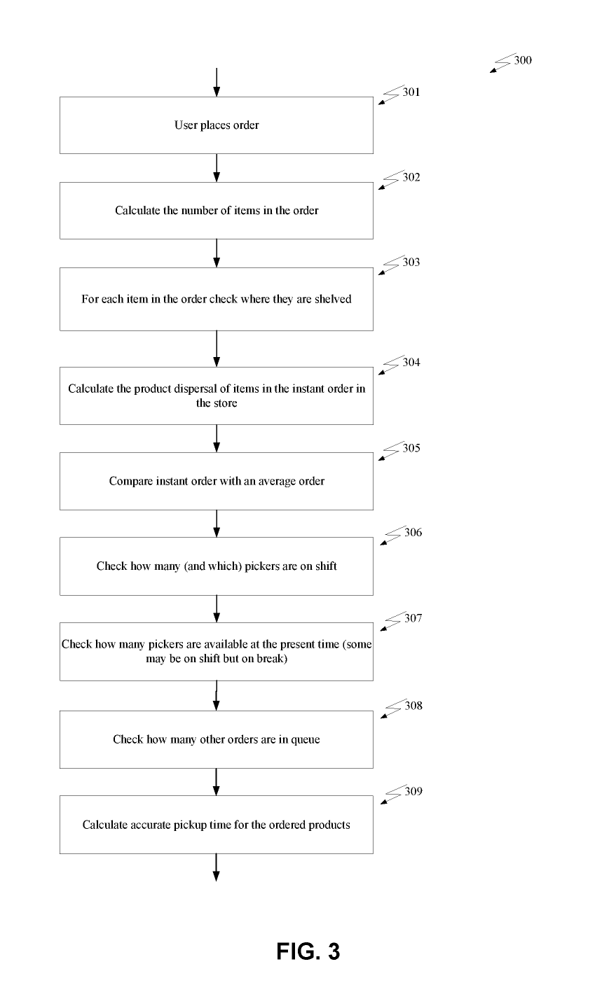

FIG. 3 shows one embodiment of the factorial assessment for the pickup time calculation 300. The user places an order 301. In one embodiment, a user may use a connected device e.g. a Smartphone, a tablet, or a personal computer to connect with the system, e.g. using a browser on a personal computer to access the website or via an app on a mobile device. In one embodiment, the app may be downloaded from an AppStore.

In the preferred embodiment, the system and method may be implemented on a server. A server may be a standalone computer that is connected to the internet or other network.

The number of items in the order may be calculated 302. A large order with many items will take longer to pick while a small order with only a few items will take a shorter duration to be picked. Further, the system may check whether the order should be split among multiple pickers, such as to maintain a benchmarked time for completion (e.g. separate pickers in each major department—bakery, produce, frozen goods, fresh deli meats, pre-made perishables, etc.).

For each item in the order the system preferably checks where the item is shelved physically in the store 303. The physical location of different items in the order may vary from site to site and may depend on where the vendor store is located and its size.

The product locational dispersion of ordered items in the store may also be calculated 304 (i.e. in what vicinity the products are). Thus if the items in the order are spread all over the store then the product dispersion is high, while if the items in an order are located in the same aisle or aisles close by then the product dispersion is low. Therefore, it can be noted that picking an order with a low product dispersion will take a comparatively shorter time while picking an order with a high product dispersion will take a comparatively longer time.

An instant order may be compared with an average order 305. By comparing the instant order with an average order it can be evaluated how different the instant order is from the average order. Thus the time to pick and assemble instant order can be varied by the same degree that it varies from an average order.

The system may check how many (and which) pickers are on shift 306. The number of pickers that are on shift may vary based on the time of the day, day of the week/month, and other factors like holidays and festivals. The system may also look at which pickers are on shift as they may have individual efficiency metrics.

The system may check how many pickers are available at the present time (some may be on shift but on break, on a washroom break, or out temporarily due to an unforeseen emergency) 307. The number of pickers may vary during a given shift as some pickers may be busy while some others may be on break e.g. lunch break.

The system may check how many other orders are in queue 308. The other orders that are in queue will have a rolling effect on the instant order, as the pickers will be first assigned to pick and assemble orders that have been received prior to the instant order. Thus the number of orders in the queue and their size and complexity will have an impact on the calculation of the pickup time of the instant order.

An accurate pickup time for the ordered products is then calculated 309. When calculating the accurate pickup time for the ordered products in the instant order, some or all of the factors described above may be used. In other embodiments, there may be other factors that are relevant to that particular implementation. Thus the above are exemplary and not limiting.

The accurate pickup time may be adjusted to compensate for the personal variations of the speed at which the individual staff members work. Thus, if a picker(s) is assigned who is agile and works at a rate which is faster than the average, the pickup time may be adjusted by taking into account the personal variation in speed of the individual picker who is assigned to pick the order. Similarly, if a picker who is relatively slower than the average, and has been assigned to pick an order, the accurate pickup time may be adjusted by taking into account the personal variation in speed of the individual picker.

When checking how many pickers are on shift and how many pickers are available to pick/assemble an order, the system may take into account the personal variation in speed for each of the pickers who are on shift and available or working in a queue already picking previous orders.

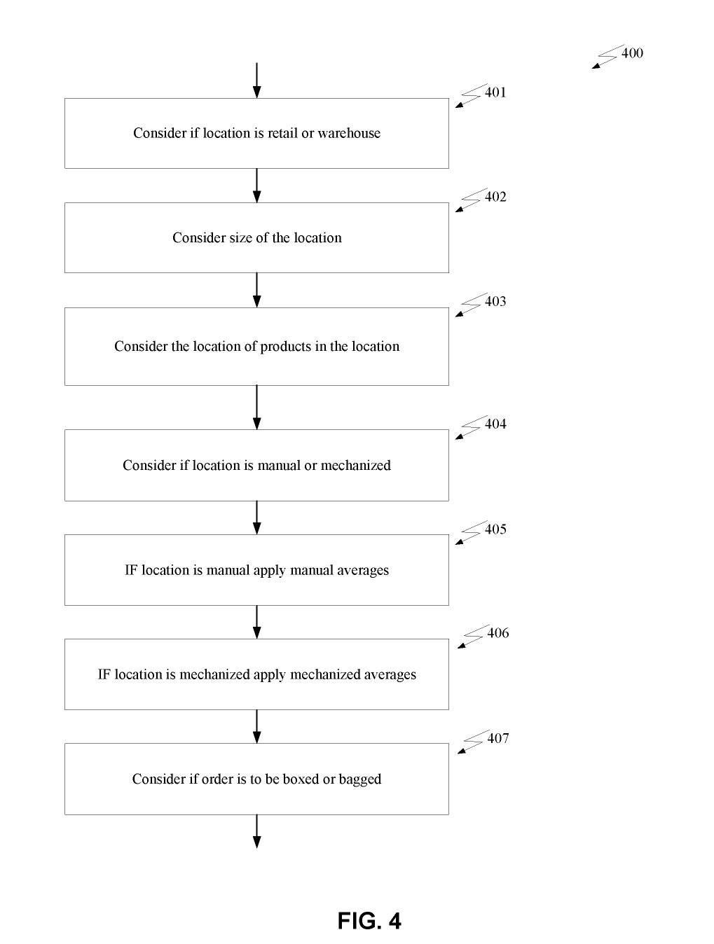

FIG. 4 shows one embodiment of the locational factors 400. The system may consider if the picking location is retail or a warehouse 401.

The system may consider the size of the location 402. If the location is retail, it may be a small store, a standard grocery store or a super store. If the location is a warehouse, it may be big or small. There may also be multiple levels in the location. The factors in terms of the size of the store will have an impact on the time it takes to assemble the order and have it ready for pickup. Thus if the store is very large it will take a picker longer to walk the aisles to pick the different items in the order as opposed to a store with a smaller footprint where items and aisles are relatively closer to each other.

The system may consider the location of products in the location 403. In one embodiment, consider the location of products in the store. Thus where ordered items are placed in the store and how far they are from each other can impact the time it will take to assemble the order and have it ready for pickup.

In one embodiment, a typical order (average order) is considered and how close or far ordered products are from each other may be analysed. Using this information, the server may create a dispersion map that may display and calculate the dispersion index i.e. how far are the products in the order and how the instant order compares to an average order. Thus we note that the higher the dispersion index is for an order the longer it will take to assemble the said order. This information is vital when calculating the accurate pickup time based on the number and type of items in the order. For instance, the dispersion index may be the summed straight-line distance between all of the items in a sequence. Or, it may be a minimum (shortest) picker path distance of the sequence of items in a continuous traversable path. If the traversable path is significant, collection may be allocated by department (bakery, meat, etc.). The items in the list may first be sorted so that locationally-adjacent items may be grouped or ordered together.

The system may consider whether the location is manual or mechanized 404. If the location is mechanized, for example, it may use motorized trolleys or golf carts for the pickers to assemble the order. If the location is manual an employee or another person may be assigned by the vendor to use a push trolley or use a basket to collect the items that have been ordered.

If the location is manual, manual averages may be applied 405. Thus the time required to pick/assemble the order will vary based on the fact that the location is manual and a person (picker) needs to take a manual trolley to physically pick the items in the instant order from different shelves.

If the location is mechanized, mechanized averages may be applied 406. Similarly, the time required to pick/assemble the order will depend on the speed of the mechanized portions of the order assembly, e.g. how fast can the golf cart be driven from aisle to aisle when picking the items in the instant order. By taking these variables into account a more accurate pickup time is provided to the user when placing an online order.

Likewise, locations with automated or robotic picking technology may have separate variables that are taken into account.

The system may consider if order is to be boxed or bagged or placed in temperature controlled containers 407. The time required to bag or box (or use temperature controlled containment) may vary depending on the nature of the items in the order and this time is taken into account when providing an accurate pickup time to a user placing an online order.

In one embodiment, the order picking and assembling location may be different from the order pickup location. For example, a warehouse or super store may assemble the individual orders and these orders are then delivered to different pickup locations in the vicinity. Therefore, the system may take into account the time it may take to have the multiple orders delivered from the warehouse location to the individual pickup location that has been specified by the consumer. As an example, the warehouse may prepare multiple orders and these may be delivered to different locations e.g. all orders in a high rise building may be delivered to the lobby, or an order may be delivered to a consumer at a subway station, or a particular intersection of roads, or a designated drop-off kiosk or locker, etc.

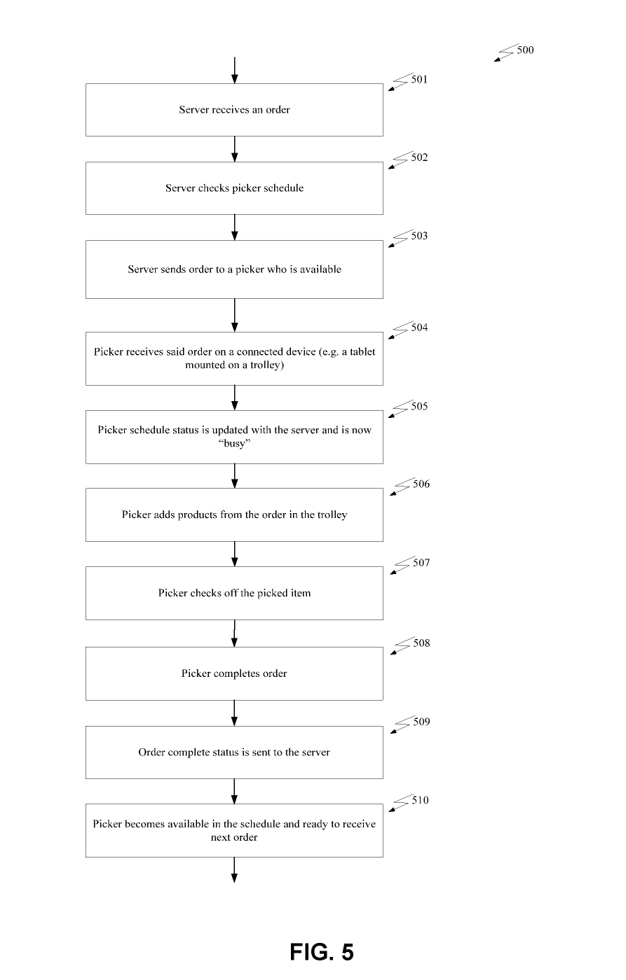

FIG. 5 shows one embodiment illustrating a sample picker device process 500. The server receives an order and checks the picker schedule 501.

In the preferred embodiment, the program code may execute entirely on the server (or a cluster of servers), partly on a server and partly on a user's computer, as a stand-alone software package, partly on the user's computer and partly on a remote computer or entirely on the remote computer or server. In the latter scenario, the remote computer may be connected to the user's device e.g. a Smartphone through any type of network, including a local area network (LAN) or a wide area network (WAN), or the connection may be made to an external computer (for example, through the Internet using an Internet Service Provider).

There may be one or more pickers on schedule to pick the items of an order assigned to them. The schedule of work shifts, the start time and the end time of the work shifts, the number of pickers in each shift and other relevant information may be available electronically on the server so that when calculating the accurate time of pickup this vital information may be taken into account.

The server sends the order to a picker who is available 502. In one embodiment, server sends order to a picker who is available in a queue. The order may be assigned to a picker in any number of different ways e.g. e-mailed to a mobile device like a Smartphone carried by the picker, a connected tablet mounted on a trolley or other cart or the picker may be provided with a paper based print out of the ordered items etc.

In one embodiment, the server may send the order to the next available picker while in an alternate embodiment the server may send the order to a picker best suited for the assembling the order, or may send the order to more than one picker to assemble, thus the order is split between more than one pickers and is assembled at the end for pickup.

The picker receives the order on a connected picker device (e.g. a tablet mounted on a trolley) 503. In one embodiment, picker receives said order on a connected device (e.g. a tablet mounted on a trolley). The tablet may be installed with a purpose built application that receives the order that has to be picked and provides a graphical user interface that a picker can use to keep track of the items that are still pending to be picked. The app may also provide visual or audible help to a picker to provide information as to where products in instant order are located in the store. In one embodiment the list of items in an order to be picked up is displayed for the picker such that products that are close to the starting point are listed first and the products close to the end are listed last, while products that are shelved in aisles close by are listed close by to aid the picker in picking the items in the order.

The picker schedule status is updated with the server and is now “busy” 504.

The picker proceeds to add products from the order to the trolley 505. The list of items may be listed in the best possible order to pick, e.g. the server calculates the vicinity of the products that are placed in the same aisle or are close to each other and puts them next to each other in the list; thus making the process more efficient and effectively decreasing the overall time it takes to assemble the order.

The picker checks off the picked item 506. For example, if the picker is using a connected device like a trolley mounted tablet computer, the picker can use a Graphical User Interface (GUI) on the device to update the status of each item in the order. In certain embodiments, this may also be automatically detected as items are placed in the cart (e.g. by scanning barcodes, RFID tags, detecting item weights or visually scanning items, and other methods).

The picker completes order 507. In one embodiment the picker may then complete the order by providing a status update using a GUI on a connected device.

The order complete status is sent to the server 508.

The picker then becomes available in the schedule and ready to receive the next order 509.

In one embodiment, one picker may be assigned to pickup more than one order(s) at the same time. Different methods may be available when assembling and picking more than one orders e.g. using two different colored bins to assemble two different orders.

In another embodiment, more than one picker may be assigned to pickup and assemble one order. Different methods may be available when more than one pickers are assigned to assembling and picking one large order e.g. all three pickers assigned to pick and assemble a large order are give same colored bins or the bins may be numbered or serialized for recognition that the items in them belong to the same order.

One embodiment may employ “runners” who are assigned to take an assembled order to the consumer's vehicle, which may be parked in a designated order pickup spot in the parking lot. The average time for a runner to take an order from the check out or other location within the retail environment to the parked consumer vehicle may also be calculated and used when providing an accurate pickup time to a consumer.

In one embodiment, there may be crowd sourced “Personal Drivers” available in the area of the store/user placing the online order. These personal drives then may collect the order that has been picked and assembled by the pickers at the say grocery store to be delivered to the user who has placed the online order. Thus the time calculated is based on picking time and distance from store/fulfillment centre to user's home/residence/address of delivery based on the local traffic, weather conditions etc. also taken into account.

In one embodiment, a personal driver may fulfil more than one pickup and delivery items for a given user. For example, a personal driver may make multiple pickups: dry cleaning, alcoholic beverages from a licensed store and groceries. The system and method in this case takes into account some or all of the following variables: nearest driver that is available, the time needed to collect items at each store, the time needed to drive there and the distance from store(s) to customer home/residence/address of delivery.

The preferred embodiment may be implemented in a grocery store which has a wide range of products including perishable and tinned items, delicate and robust items, small and large items etc.

An alternate embodiment may also be implemented in a Big Box home improvement store, where the variables for calculating the accurate pickup time may be different. For example, in an order that includes lumber and other heavy items, the availability of a forklift or a crane may be a crucial bottleneck. Thus knowing when a forklift or a crane may become available to pick heavy items in said order will have an impact on determining the pickup time accurately.

In one embodiment, the payment may be made online when the order is being placed by a user. In another embodiment, the payment can be made by the user placing the order at the time of pickup. While in yet another embodiment the payment can be made using a loyalty card or by using points or other rewards accumulated by the user over a period of time.

The user may also be presented with the accurate pickup time via an e-mail, a text message, a voice mail, a link being added to their homepage on a social media website e.g. Facebook homepage. In one embodiment there may be an application either generic or purpose built, such that the user can place an online order using this application. The application may be specific for a particular mobile device e.g. an iPhone or a Google Android phone, or a tablet computer etc. or generic e.g. Flash or HTML5 based app that can be used in a browser.

In one embodiment, the system may also provide a notification service. The notification service may provide a notification to the user regarding time till order is ready. The notification service of the system may also provide periodic reminders. Such notifications may also be sent via e-mail, text message, phone call, via a purpose built application etc. or may be via the social network e.g. Facebook page, Google+, Twitter etc.

These descriptions exemplify only some of the several possible embodiments and are not meant to be exhaustive. The intent is to cover all such possibilities and combinations that are obvious to the ones skilled in the art.

It should be understood that although the term application has been used as an example in this disclosure but in essence the term may also imply to any other piece of software code where the embodiments are incorporated. The software application can be implemented in a standalone configuration or in combination with other software programs and is not limited to any particular operating system or programming paradigm described here.

The computer program comprises: a computer usable medium having computer usable program code, the computer usable program code comprises: computer usable program code for presenting graphically to users options for scrolling via the touch-screen interface.

The examples noted here are only for illustrative purposes and there may be further implementation embodiments possible with a different set of components. While several embodiments are described, there is no intent to limit the disclosure to the embodiment or embodiments disclosed herein. On the contrary, the intent is to cover all practical alternatives, modifications, and equivalents.

What is claimed is:

1. A method of providing an accurate, timely and precise pickup time for a multi-product order, comprising:
receiving a first item selection in an order from a user through an online order interface;
receiving a second item to be added to the order from the user through the interface;
calculating a first pickup time based on a factorial assessment, the assessment including as one factor the locational dispersion of the items from each other in a picking facility;
providing a first notification to the user of the first pickup time, and allowing the user to change or delete any of the items to modify the first pickup time before finalizing the order;
dynamically tracking picking of the order at the picking facility and calculating a second pickup time based on the completion of the picking of the order; and
providing a second notification to the user of the second pickup time, as a modification of the first pickup time.

2. The method of claim 1, wherein the factorial assessment further includes the number of items in the order.

3. The method of claim 1, wherein the factorial assessment further includes the position of each of the items on shelves in the picking facility.

4. The method of claim 1, wherein the factorial assessment further includes a schedule of pickers in the picking facility.

5. The method of claim 1, wherein the factorial assessment further includes current or near-term availability of pickers in the picking facility.

6. The method of claim 1, wherein the factorial assessment includes speed of pickers in the picking facility.

7. The method of claim 1, wherein the factorial assessment includes orders in queue for the picking facility prior to the user's order.

8. The method of claim 1, wherein the factorial assessment includes specific packaging requirements for any of the items in the order.

9. The method of claim 1, wherein the factorial assessment includes overall size of the picking facility.

10. The method of claim 1, wherein the factorial assessment includes availability of manual or mechanized trolleys in the picking facility.

11. The method of claim 1, further comprising allowing the user to enter a desired pickup time and wherein the first notification advises the user if the desired pickup time is unobtainable given the calculated first pickup time.

12. The method of claim 11, further comprising allowing the user to revise either the order or the desired pickup time if unobtainable.

13. The method of claim 1, wherein the first pickup time is displayed as a running total as the items are added to the order.

14. The method of claim 1, wherein the locational dispersion comprises the minimum straight-line distance between the items.

15. The method of claim 1, wherein the locational dispersion comprises the minimum picker path distance between the items.

16. The method of claim 1, wherein locationally-adjacent items are grouped or ordered together prior to calculation of locational dispersion.

17. The method of claim 1, wherein tracking the picking of the order is by picker- or trolley-mounted tracking device.

18. The method of claim 1, wherein the picking facility is a grocery store, big box store, or pharmacy, or a distribution centre or a warehouse of a grocery store, big box store, or pharmacy.

19. A picker device for providing an accurate, timely and precise pickup time for a multi-product order to be picked by a picker in a picking facility, the device comprising:
a picker- or trolley-mounted portion; and
a device portion that includes programming to:
receive an order for picking, the order including multiple items, and a first pickup time that had been previously provided to a user when the order was entered;
display the order to the picker such that the items are arranged according to minimum product dispersion in the picking facility;
receive an indication from the picker or the trolley that the item has been picked; and
calculate a second pickup time based on actual completion of the order for pickup.

20. The device of claim 19, wherein the first pickup time is displayed to the picker.

21. The device of claim 19, wherein the device portion is further programmed for tracking and displaying to the picker the progress to completion of the order.

22. The device of claim 19, wherein the device portion is further programmed for assessing points or credits to the picker if the first pickup time is met or improved.

23. The device of claim 19, wherein the order is marked complete when all items have been picked and packaged for pickup.

24. The device of claim 19, wherein the device portion is further programmed for giving visual or audio directions as to the location of the next item for picking.
